(19) United States
(12) Patent Application Publication
(10) Pub. No.: US 2010/0012569 A1
(43) Pub. Date: Jan. 21, 2010

(54) HOT WATER FILTER FOR A DISHWASHER

(76) Inventors: Michael A. Ambroiggio, Crest Hill, IL (US); Tom Ambroiggio, Algonquin, IL (US)

Correspondence Address: PATZIK, FRANK & SAMOTNY LTD., 150 SOUTH WACKER DRIVE, SUITE 1500, CHICAGO, IL, 60606, US

(21) Appl. No.: 12/530,299

(22) PCT Filed: Mar. 7, 2008
(86) PCT No.: PCT/US08/56124

§ 371 Date: Sep. 8, 2009

Related U.S. Application Data
(60) Provisional application No. 60/922,690, filed on Apr. 9, 2007.
(60) Provisional application No. 60/986,618, filed on Nov. 9, 2007.
(60) Provisional application No. 60/905,409, filed on Mar. 7, 2007.
(60) Provisional application No. 60/918,858, filed on Mar. 19, 2007.
(60) Provisional application No. 60/922,900, filed on Apr. 11, 2007.

(51) Int. Cl. B01D 35/30; A47L 15/42

(52) U.S. Cl. 210/232

(57) ABSTRACT

A hot water filter (30) for a dishwasher (10) having a base (34) connected to a hot water line (28) to allow water to be filtered prior to introduction into the dishwasher washing compartment, a filter element (42) and a housing element (40) for attaching to the base (34) and enclosing the filter element (42). The filter element (42) includes one or more stages or layers (70, 72, 74, 76) to filter the water. In one embodiment, the filter element (42) has a cation resin layer (74), a carbon layer (72) and one or more water permeable layers (70, 76).

This application claims benefit to U.S. Provisional Patent Application No. 60/986,618, filed Nov. 9, 2007; U.S. Provisional Patent Application No. 60/922,900, filed Apr. 11, 2007; U.S. Provisional Patent Application No. 60/922,690, filed Apr. 9, 2007; U.S. Provisional Patent Application No. 60/918,858, filed Mar. 19, 2007; and U.S. Provisional Patent Application No. 60/905,409, filed Mar. 7, 2007.

### TECHNICAL FIELD

The invention relates to hot water line filters for dishwashers.

### BACKGROUND ART

While electronic dishwashers provide a means to readily clean dishes with less manual labor, many dishwashers leave spots, films or other residue on the dishes after completion. This can lead to having to manually or otherwise rewash the dishes—thereby eliminating the benefits of an automatic dishwasher—serving dishes that give the appearance of being unclean or dirty.

While most people assume that faulty or outdated dishwashers cause spots and films on dishes, Applicants have determined that most blemishes are caused by minerals (e.g., calcium or magnesium) and other sediments in the water itself. Accordingly, in addition to “dirty” dishes, continued use of such water can lead to, among other things, buildup in the mechanical parts of the dishwasher, thereby causing damage to the dishwasher or lowering the length of the dishwasher's life.

### DISCLOSURE OF THE INVENTION

The present invention is an improvement over the prior dishwasher filtering systems in the way that the hot water filter filters water going into the dishwasher. In one embodiment, a base having an inlet and an outlet is positioned within an opening in the dishwasher to allow hot water to travel through the inlet and out the outlet after being filtered. In particular, the inlet leads into the inside of a housing member 40 that is sealingly attached to the base and which encloses a filter element.

The filter element comprises one or more layers or phases to filter the hot water prior to its introduction into the dishwasher washing compartment. In order to reduce film and sediment like sand and rust, the water may first pass through a water permeable layer such as polypropylene wound fibers. An activated carbon phase or layer may be used to, among other things, improve the taste and odor of the water. The filter element also includes a cation resin layer or phase to filtrate and remove calcium and magnesium from hard water, while replacing it with sodium. This will allow the consumer to use less dishwashing detergent because removal of the calcium and magnesium from the water allows the detergent to better mix with the softened water. Another water permeable layer such as polypropylene wound fibers may be located towards the outlet end of the filter element.

It is therefore an object of the present invention to provide a new system and method for introducing clean water into a dishwasher.

Another object of the present invention is to provide a new system and method for cutting down on chlorine and mineral deposits in dishwashers.

It is yet another object of the present invention to provide a new system and method for filtering out rust and sediments from dishwasher water.

Still yet another object of the present invention is to provide a system and method for extending the life of a dishwasher.

Another object of the present invention is to provide a system and method for removing taste and odor from dishwasher water.

Other objects, features and advantages of the invention will be apparent from the following detailed disclosure, taken in conjunction with the accompanying sheets of drawings, wherein like reference numerals refer to like parts.

### BRIEF DESCRIPTION OF THE DRAWINGS

The design of the system can be better understood by following the description of the drawings set forth herein. A brief description of each figure is included here.

FIG. 1 is a front elevated view of one embodiment of a dishwasher utilizing a hot water line filter of the present invention.

FIG. 2 is a perspective view of one embodiment of the hot water line filter of the present invention.

FIG. 3 is a perspective inverted and exploded view of the hot water line filter of FIG. 2.

FIG. 4 is a cross-sectional view of the hot water line filter of FIG. 2 taken along line 4-4, with arrows showing the directional flow of water through the filter.

FIG. 5 is a top perspective view of one embodiment of the base of the filter.

FIG. 6 is a bottom plan view of the housing of the filter of FIG. 2.

### DETAILED DESCRIPTION OF THE INVENTION

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

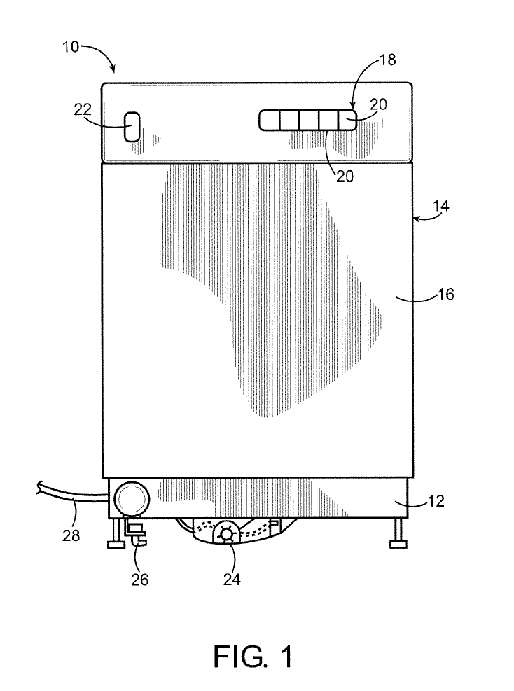

Referring to FIG. 1, one embodiment of a dishwasher is shown. The undercarriage 12 supporting a frame 14 having a door 16 that is hingedly attached to the frame to permit access to the washing compartment of the dishwasher 10. A control panel 18 having a series of buttons 20 may be located at the top of the frame 14 to control the operation of the dishwasher 10. It is also appreciated that the control panel may be a touch screen or other known controls for dishwashers. A power switch 22 (i.e., an on/off switch) may be located with the other buttons of the control panel or separate to allow for the selective operation of the dishwasher.

A drive device such as a motor 24 may be located under or within the undercarriage to drive a wash pump (not shown) integrated with a rotating spray arm (not shown), and a drainage pump (not shown). A water solenoid 26 for controlling the flow of water into the dishwasher is shown on the bottom of the dishwasher. In a preferred embodiment, the kick panel or undercarriage 12 will include a panel that may be removed or opened to reveal an opening for receiving a filter system 30 of the present invention. A water line 28 connects the dishwasher to a hot water source to provide hot water for use in the dishwasher.

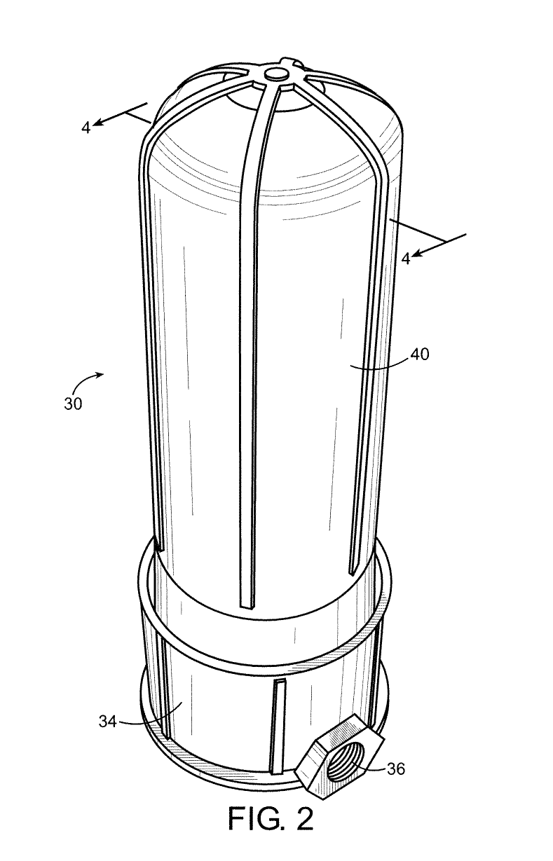

Referring now to FIGS. 2 through 4, one embodiment of the filter system of the present invention is shown. The filter system, generally designated by the number 30, includes: a base 34 with a hot water inlet 36 and a hot water outlet 38; a housing element 40 and a filter element or cartridge 42.

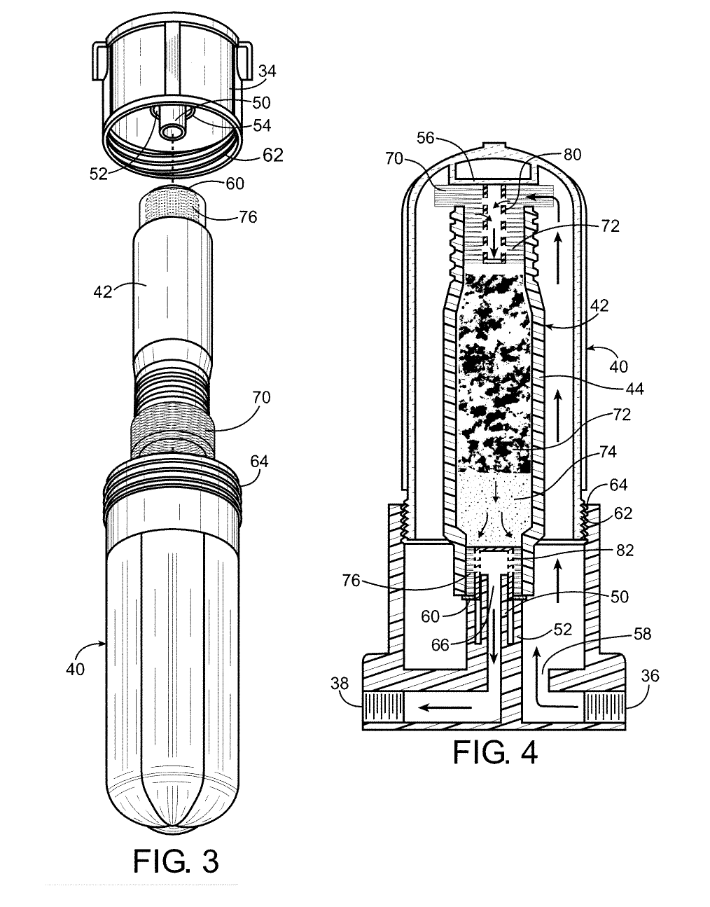

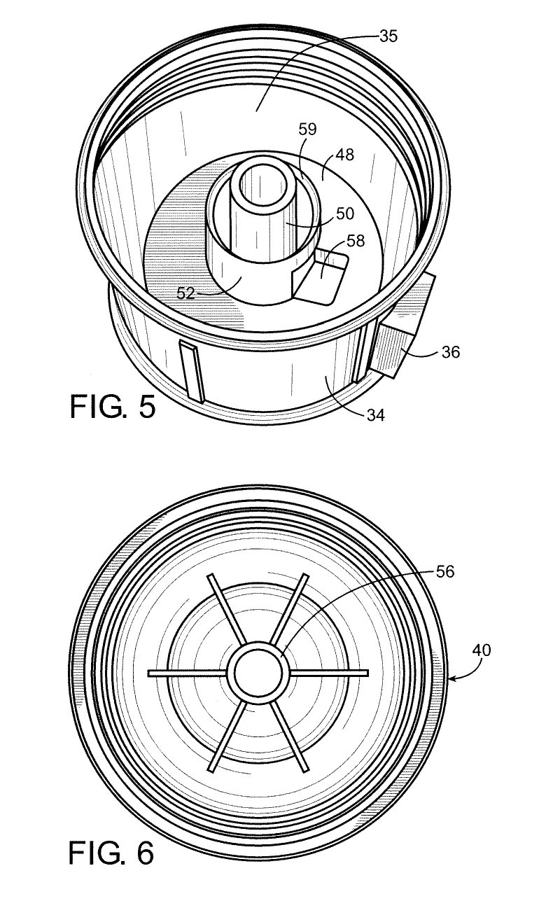

As shown in FIGS. 3 and 5, a top wall 48 extends across the interior width of the base 34 to define a cavity with the base's interior or circumferential walls 35. One embodiment of the base 34 includes a central conduit 50 extending upward from the base and which is operably connected to the hot water outlet 38 to allow filtered water to flow into the dishwasher.

A cylindrical wall 52 extends about the bottom of the conduit 50, wherein the top of the cylindrical wall 52 provides a top surface 54 for engaging the end of the filter element 42 and creating a seal thereto. While a cylindrical wall is shown and disclosed, it is appreciated that other known methods of operably connecting or locating the filter element relative to the conduit may be used including, but not limited to, a threaded connection or twist locks and not depart from the scope of the present invention.

An opening 58 in the top wall 48 in an area outside of the cylindrical wall provides a passage to operably connect the cavity of the base 34 to the hot water line inlet 36 to permit water to flow into the base 34 and filter element 42. While the housing element 40 and base 34 may be sealingly connected in any known way, referring to FIGS. 3 and 4, one embodiment utilizes corresponding threads 62, 64 on the respective ends of the base 34 and housing element 40 to permit the housing element 40 to be twisted into engagement with the base 34. The base and housing elements may be made out of a variety of non-water-permeable materials including, but not limited to, various polymers or steel.

As shown in FIG. 4, the filter element or cartridge 42 includes a number of different sections or phases for water to pass through. In one embodiment, the cartridge may be sized such that it is about 10 inches long and 2½ inches wide to go into a standard 10 inch housing element; however, it is appreciated that it may be of a variety of different sizes and shapes depending on the system that is used in and not depart from the scope of the invention. The filter element 42, in the embodiment shown in FIGS. 4 and 5, is sized to snuggly fit between the top surface 54 of the cylinder wall 52 and the inside 56 of the top of the housing element 40. A rubber O-ring gasket 60 may be used at the bottom of the filter element to assist in providing a sealed connection with the cylindrical wall 52. In order to prevent the water from entering the filter element other than through the first water permeable layer or inlet, the filter element preferably includes a protective casing 44 around most of the filter element. The casing is preferably a thin polymer casing, but may be made of a variety of thicknesses and materials that are not water permeable.

When installed, water entering from the hot water inlet will pass through the base and pocket in the housing about the filter element and enter the filter element about it through an inlet at or proximate its top end (with reference to the view in FIG. 4). Referring now to FIG. 4, a water permeable layer 70 may be located at or near the top or inlet of the filter element 42 to permit water to enter the filter element 42 for processing. One such embodiment of a water permeable layer is made of polypropylene (e.g., polypropylene wound fibers) 70, which act to reduce film and sediment like sand and rust in the water. A perforated interior wall 80 may be used to provide support to the wound fibers or other water permeable layer 70, and to permit water to flow into the interior of the filter cartridge 42. When water does not enter the filter element through an opening in the top of the filter element, it is appreciated that a rubber O-ring gasket may also be used at the top of the filter element to provide a sealed connection with the inside of the top of the housing.

An activated carbon layer 72 may be located within the filter element 42 after the water permeable layer 70 to filter out harmful chemicals and to improve the taste and odor of the water. The third phase or layer 74 includes cation resin, which filtrates and removes calcium and magnesium from hard water, and replaces it with sodium. Using the activated carbon layer before the cation layer will increase the life of the cation layer. The cation resin also acts to reduce spotting of dishes caused by hard water (e.g., calcium and lime deposits), and filtrates aluminum and lead. An example of a cation resin that may be used is Indion 225Na (crosslinked polystyrene and sulphonic acid) by Ion Exchange India Limited.

A fourth phase or layer 76, which may be located towards the outlet end of the filter element 42, also may be a water permeable material such as, but not limited to, polypropylene wound fibers. A perforated interior wall 82 may be used to provide support to the wound fibers or other water permeable layer 76, and to permit water to flow into the opening 66 of the filter cartridge 42 to permit water to flow out of the filter cartridge 42 and through the hot water outlet 38. While the embodiment shown in the drawings is preferred, it is appreciated that the phases may be used in different orders and/or include different elements.

In order to assist and retain the filter element 42 relative to the base 34, the bottom end of the filter element 42 may include an opening 66 that is sized to accept the end of the central conduit 50 of the base 34. While the filter element is shown as having a substantially cylindrical cross-section, it is appreciated that it may be of a variety of other cross-sections and not depart from the scope of the present invention.

In operation, the base is installed within a dishwasher unit with the hot water line 28 connected to the hot water inlet 36 of the base 34 and the hot water outlet 38 being connected to an internal hot water line for dispensing hot water within the washing compartment of the dishwasher 10. It is also appreciated that the base may be built into the dishwasher during manufacture. In order to permit replacement of a spent filter cartridge 42, the base 34 may be aligned with an opening in the front or kick panel 12 of the dishwasher. If a filter element 42 is being replaced, the housing element 40 may be twisted in a counterclockwise direction to disengage the threads 64 of the housing element 40 from the corresponding threads 62 of the base 34. The housing element 40 and the filter element 42 may be removed through the opening of the dishwasher 10. Thereafter, a new filter element 42 may be placed through the opening so that the opening 66 in its bottom end extends over the central conduit 50. The housing member 40 may then be inserted over the filter element 42 until its threads 64 engage the threads 62 at the top of the base 34, wherein it may be rotated in a clockwise direction to removably fix the housing element 40 to the base 34.

In use, hot water flows through the hot water line and the hot water inlet 36 in the base 34 and into the cavity defined by the base 34 through opening 58. The water then flows into the pocket in the housing element 40 (defined by the filter element and the interior wall of the housing element) and through the water permeable layer 70 into the filter element 42. After passing through the activated carbon and cation resin layers 72, 74, the water passes through the second water permeable layer 76 and into the central conduit 50, where it then proceeds through the hot water outlet 38 into the dishwasher unit.

Many modifications and variations of the present invention are possible in light of the above teachings. It is therefore to be understood that within the scope of the appended claims, the invention may be practiced otherwise than as specifically described. Various modifications, changes and variations may be made in the arrangement, operation and details of construction of the invention disclosed herein without departing from the spirit and scope of the invention. The present disclosure is intended to exemplify and not limit the invention.

What is claimed is:

1. An inline hot water filter (30) for a dishwasher (10) connected to a hot water line (28), the filter (30) comprising:
a base (34) having a hot water inlet (36) and a hot water outlet (38), the hot water inlet (36) operably attachable to the hot water line (28);
a filter element (42) having a first end, a second end and a cation resin laye (74)r, the filter element (42) positioned to permit water to flow through the filter element (42), out the second end and through the hot water outlet (38); and
a housing member (40) removably attachable to the base (34) for enclosing the filter element (42), wherein the housing member (40) and filter element (42) define a pocket within the housing member (40) to permit water to flow from the base (34) and into the filter element (42).

2. The filter (30) of claim I wherein the filter element (42) further comprises an activated carbon layer (72) before the cation resin layer (74).

3. The filter (30) of claim 1 wherein the filter element (42) further comprises a water permeable layer (70) at or proximate the filter element (42) first end and before the cation resin layer (74).

4. The filter (30) of claim 3 wherein the water permeable layer (70) includes polypropylene wound fibers.

5. The filter (30) of claim 2 wherein the filter element (42) further comprises a water permeable layer (70) at or proximate the filter element (42) first end and before the cation resin layer (74).

6. The filter (30) of claim 5 wherein the water permeable layer (70) includes polypropylene wound fibers.

7. The filter (30) of claim 5 wherein the filter element (42) further comprises a second water permeable layer (76) located at or proximate the filter element (42) second end and after the cation resin layer (74).

8. The filter (30) of claim 7 wherein the first and second water permeable layers (70,76) include polypropylene wound fibers.

9. The filter (30) of claim 1 wherein the base (34) and the housing element (40) include corresponding threaded ends (62,64) for attaching the housing element (40) to the base (34).

10. The filter (30) of claim 1 which further includes a seal element (60) between the filter element (42) and at least one of the housing element (40) and base (34).

11. The filter (30) of claim 10 wherein the seal element (60) is a rubber gasket.

12. The filter (30) of claim 1 wherein the base (34) includes:
a circumferential side wall;
a top wall (48) extending between the circumferential side wall (35) to create a cavity therein;
an opening (58) in the top wall (48) operably connecting the hot water inlet (36) and the cavity;
and a central conduit (50) extending through the top wall (48) and being operably connected to the hot water outlet (38).

13. The filter (30) of claim 12 wherein the filter element (42) includes an opening (66) sized to snuggly fit over the central conduit (50).

14. An inline hot water filter (30) for a dishwasher (10) connected to a hot water line (28), the filter (30) comprising:
a base (34) having a hot water inlet (36) and a hot water outlet (38), the hot water inlet (36) operably attachable to the hot water line (28);
a filter element (42) having an inlet and an outlet, the filter element (42) positioned to permit water to flow through the filter element (42) and out of the hot water outlet (38), the filter element (42) including:
a first water permeable layer (70) at or proximate the inlet to permit water to enter the filter element (42);
an activated carbon layer (72); and
a cation resin layer (74); and
a housing member (40) removably attachable to the base (34) for enclosing the filter element (42), wherein the housing member (40) and filter element (42) define a pocket within the housing member (40) to permit water to flow from the base (34) and into the filter element (42) inlet.

15. The filter (30) of claim 14 which further comprises a second water permeable layer (76) located at or proximate the filter element (42) outlet.

16. The filter (30) of claim 15 wherein the base (34) includes:
a circumferential side wall;
a top wall (48) extending between the circumferential side wall (35) to create a cavity therein;
an opening (58) in the top wall (48) operably connecting the hot water inlet (36) and the cavity; and
a central conduit (50) extending through the top wall (48) and being operably connected to the hot water outlet (38).

17. The filter (30) of claim 15 wherein the first and second water permeable layers (70, 76) include polypropylene wound fibers.

18. The filter (30) of claim 14 wherein the activated carbon layer (72) is positioned before the cation resin layer (74).
